(19) United States
(12) Patent Application Publication
(10) Pub. No.: US 2019/0302809 A1
(43) Pub. Date: Oct. 3, 2019

(54) UNMANNED VEHICLE ANTENNAE CONTACT SENSOR SYSTEMS AND METHODS

(71) Applicant: Walmart Apollo, LLC, Bentonville, AR (US)

(72) Inventors: Donald R. High, Noel, MO (US); Robert L. Cantrell, Herndon, VA (US); Todd D. Mattingly, Bentonville, AR (US)

(21) Appl. No.: 16/366,083

(22) Filed: Mar. 27, 2019

Related U.S. Application Data
(60) Provisional application No. 62/650,561, filed on Mar. 30, 2018.

(51) Int. Cl. G05D 1/10; B64C 39/02

(52) U.S. Cl. CPC G05D 1/106; B64C 39/024; G06Q 50/28; B64C 2201/141; B64C 2201/128

(57) ABSTRACT

In some embodiments, systems and methods provide a retail delivery unmanned aerial vehicle, comprising: a frame; a plurality of motors cooperated with the frame; a plurality of propellers each secured with one of the motors; a vehicle control circuit communicatively coupled with the motors and configured to control the motors in controlling the movement of the unmanned aerial vehicle; and an array of a plurality of tactile sensor systems each comprising: an extended feeler antenna with a distal end proximate one of the propellers and configured to flex in response to a threshold pressure from contact with an external object; and a contact sensor configured to detect contact by the extended feeler antenna with the external object; wherein the extended feeler antennae are spaced around the frame and define at least outer most lateral perimeter points laterally spaced about the unmanned aerial vehicle.

### CROSS-REFERENCE TO RELATED APPLICATION

This application claims the benefit of U.S. Provisional Application No. 62/650,561, filed Mar. 30, 2018, which is incorporated herein by reference in its entirety.

### TECHNICAL FIELD

This invention relates generally to unmanned vehicle deliveries.

### BACKGROUND

Delivery of packages and retail products can be important to many businesses. There has been significant research into improving delivery methods. Further advancements in delivery are still needed.

### BRIEF DESCRIPTION OF THE DRAWINGS

Disclosed herein are embodiments of systems, apparatuses and methods providing unmanned vehicle deliveries. This description includes drawings, wherein:

FIG. 1 illustrates a simplified overhead view of a delivery unmanned aerial vehicle (UAV), in accordance with some embodiments;

FIG. 2 shows a simplified side cross-sectional view of an exemplary delivery UAV, in accordance with some embodiments;

FIG. 3 illustrates a simplified block diagram of an exemplary unmanned ground vehicle (UGV), in accordance with some embodiments;

FIG. 4 illustrates a simplified block diagram of an exemplary tactile sensor system with an exemplary extended feeler antenna, in accordance with some embodiments;

FIG. 5 illustrates a simplified cross-sectional, block diagram of an exemplary tactile sensor system with an inertial sensor, in accordance with some embodiments;

FIG. 6 illustrates a simplified cross-sectional, block diagram of an exemplary tactile sensor system with a temperature change detection system, in accordance with some embodiments;

FIG. 7 illustrates a simplified overhead view of an exemplary unmanned vehicle, in accordance with some embodiments;

FIG. 8 illustrates a simplified block diagram of a portion of an extended feeler antenna secured with the housing, in accordance with some embodiments;

FIG. 9 illustrates a simplified block diagram of a portion of an extended feeler antenna having a spring member secured between two longitudinal body sections, in accordance with some embodiments;

FIG. 10 illustrates a simplified block diagram of an exemplary distal end portion of an exemplary extended feeler antenna, in accordance with some embodiments;

FIG. 11 illustrates a simplified block diagram of an exemplary unmanned vehicle delivery system, in accordance with some embodiments;

FIG. 12 illustrates a simplified flow diagram of an exemplary process of delivering retail products and packages using a retail delivery unmanned aerial vehicle and/or performing other retail tasks, in accordance with some embodiments;

FIG. 13 illustrates an exemplary system for use in implementing methods, techniques, devices, apparatuses, systems, servers, sources and controlling unmanned vehicles in delivering retail products, in accordance with some embodiments; and

FIG. 14 illustrates a simplified representation of a portion of an unmanned aerial vehicle carrying a package, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful in providing unmanned vehicle deliveries. In some embodiments, multiple retail unmanned delivery vehicles are provided that carry items or packages to different delivery locations. Some of the unmanned aerial vehicles include a frame, a plurality of motors cooperated with the frame, and a plurality of propellers each secured with and driven by one of the plurality of motors to provide altitude and directional movement of the unmanned aerial vehicle. One or more vehicle control circuits are further included and are communicatively coupled with the motors and configured to control the motors in controlling the movement of the unmanned aerial vehicle. An array of a plurality of tactile sensor systems are cooperate with the frame and/or a housings. In some embodiments, the tactile sensor systems each includes an extended feeler antenna and a contact sensor. The extended feeler antennae extend from the frame and/or housing with a distal end of one or more of the extended feeler antennae proximate to one of the propellers and spaced from the frame. Typically, at least some of the extended feeler antennae are configured to flex in response to a threshold pressure from contact with an external object. With some of the tactile sensor systems, the contact sensors cooperate with the extended feeler antenna and are configured to detect contact by the extended feeler antenna with the external object. In some embodiments, the extended feeler antennae of the plurality of tactile sensor systems are spaced around the frame and define at least outer most lateral perimeter points laterally spaced about the unmanned aerial vehicle.

Some embodiments provide methods of delivering retail products using retail unmanned delivery vehicles. With some delivery vehicles, a delivery route to a delivery location is received by a vehicle control circuit of a retail delivery unmanned aerial vehicle. A plurality of motors, which are cooperated with a frame of the unmanned aerial vehicle, are controlled to each drive one of a plurality of propellers to provide altitude and directional movement of the unmanned aerial vehicle in accordance with the delivery route. Contact sensor data is received at the vehicle control circuit from one or more of an array of a plurality of tactile sensor systems each comprising: an extended feeler antenna and a contact sensor. At least some of the extended feeler antennae extend from the frame with a distal end proximate one of the propellers and spaced from the frame. The extended feeler antennae are configured to flex in response to a threshold pressure from contact with an external object. In some implementations, at least some of the contact sensors are cooperated with the extended feeler antenna and configured to detect contact by the extended feeler antenna with the external object. The extended feeler antennae of the plurality of sensor systems are typically spaced around the frame and define at least outer most lateral perimeter points laterally spaced about the unmanned aerial vehicle. The vehicle control circuit is further configured to control at least one of the motors in response to the contact sensor data.

The intended utilization of unmanned vehicles is dramatically increasing. Such unmanned vehicles are operated through numerous sensor inputs to control the movement of the vehicles. Often, however, the reaction time of the vehicle and/or the sensor data is insufficient allowing the vehicle to inadvertently contact external objects. Additionally, such unmanned vehicles may put into situations where there are potential physical threats to the vehicles. As such, the extended feeler antennae provide at least some added protections to a vehicle as it travels. Previous systems may have positioned a rigid cage or other such shroud around the propellers and/or the entire vehicle in attempts to provide protection. Such cages, however, typically greatly increase the weight of such vehicles, which decrease the vehicles range of travel, mobility, time to implement commands, carrying capacity and other such drawbacks. Further, such cages often greatly increase the size of such vehicles limiting their usefulness and the areas within which such vehicles can travel.

The use of limited numbers of flexible antennae greatly increase the safety to the vehicles as well as object around the vehicles without the need for an encasing cage. Such antennae, in some applications, serve as a buffer between the vehicle (e.g., the propellers) and physical and living external objects, which could damage the vehicle or be damaged by the vehicle. The antenna structures can be configured to extend from the unmanned vehicle as part of a tactile and contact sensor system. The antenna tactile sensor system allows for close-in sense and avoid while serving as a buffer between the vehicle and external physical and/or living objects. Further, the antenna structure can be used in combination with other sensors such as video image capture, fiber optics, distance measurement systems, force measurement systems, pressure measurement systems, and the like. The unmanned vehicle may include antennae that would be oriented passively, or controlled to allow movement. Such movement may be guided by video data and/or other sensory cues. In other instances, the movement may be predefined, such as conducting sweeping patterns to provide coverage of a greater area. In some instances, the external object contacted by one or more antennae, if it has its own sensory system, may react to the touch before making contact with harmful parts of the vehicle such as the propellers. Additionally, in some embodiments, the antennae are implemented to be flexible and provide a physical cushion about the vehicle and/or elastically respond to contact with an external object to push the unmanned vehicle away from the object.

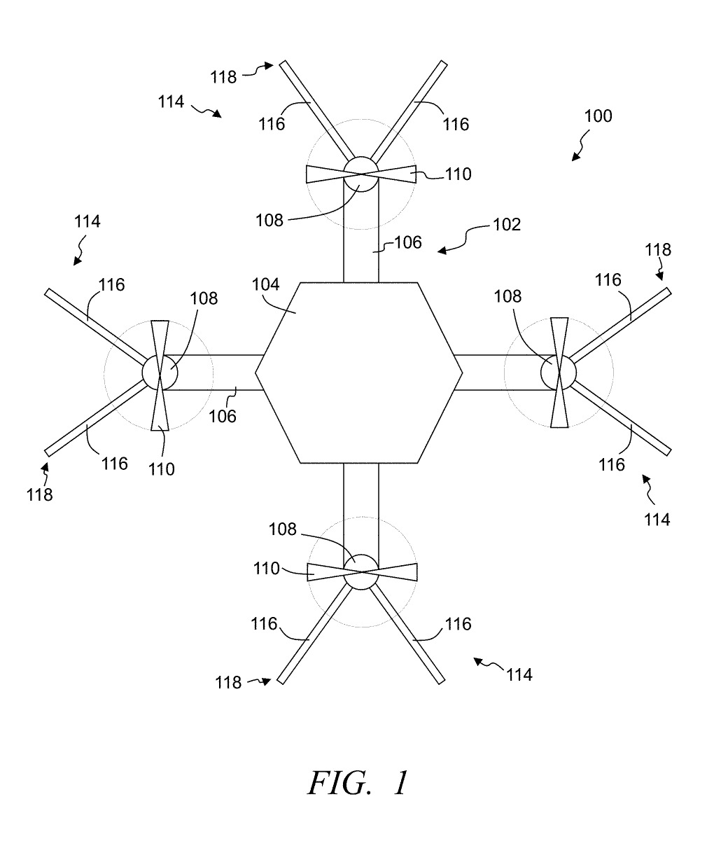

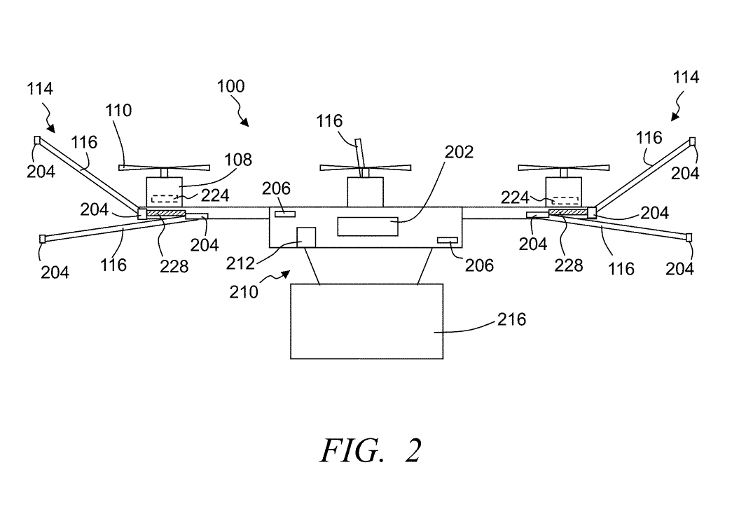

FIG. 1 illustrates a simplified overhead view of a delivery unmanned aerial vehicle (UAV) 100, in accordance with some embodiments. FIG. 2 shows a simplified side cross-sectional view of an exemplary delivery UAV 100, in accordance with some embodiments. Referring to FIGS. 1-2, the UAV 100 includes a frame 102, which typically includes a housing 104 or main body and multiple support arms 106 that each support at least one of a plurality of motors 108 to secure and cooperate the motors with the frame 102. Propellers 110 are secured with and driven by each of the plurality of motors 108 to provide altitude and directional movement of the UAV 100. The UAV further includes one or more vehicle control circuits 202. The vehicle control circuit 202 can be implemented through one or more processors and/or microprocessors with non-tangible memory or coupled with non-tangible memory storing code that is implemented by the one or more processors and/or microprocessors. The vehicle control circuit 202 is electrically and/or communicatively coupled with the motors 108 and configured to at least control the motors in controlling the movement of the unmanned aerial vehicle.

The UAV 100 further includes an array of a plurality of tactile sensor systems 114 cooperated with the frame 102. At least some of the tactile sensor systems 114 include an extended feeler antenna 116 extending from the frame 102 with an exterior or distal end 118 positioned to be proximate at least one of the propellers 110 and spaced from the frame 102. In some embodiments, one or more of the tactile sensor systems 114 further include at least one contact sensor 204 cooperated with the extended feeler antenna 116. Some extended feeler antenna 116 are cooperated with contact sensors 204 cooperated with the frame 102 and/or housing 104. Further, some extended feeler antenna 116 may include one or more contact sensors 204, such as contact sensors secured proximate the distal ends 118. Some embodiments additionally or alternatively include one or more contact sensors 204 separate from the extended feeler antennae and configured to detect contact by one or more of the feeler antennae with an external object. Typically, at least some of the extended feeler antennae 116 of the plurality of sensor systems are spaced around the frame and define at least outer most lateral perimeter points laterally spaced about the unmanned aerial vehicle.

In some embodiments, the UAV further includes one or more package carrier systems 210 configured to support one or more packages 216 while being transported by the UAV 100. Further, the package carrier system 210 may include one or more package control systems 212 that enables control over the release, lower, retracting and/or other controls over the package. For example, the package control system may include one or more crane systems, package securing systems, package release systems, and/or other such systems. In some implementations, the package control system is positioned within the housing 104 and coupled with one or more motors to control the positioning of the package relative to the frame 102 of the UAV.

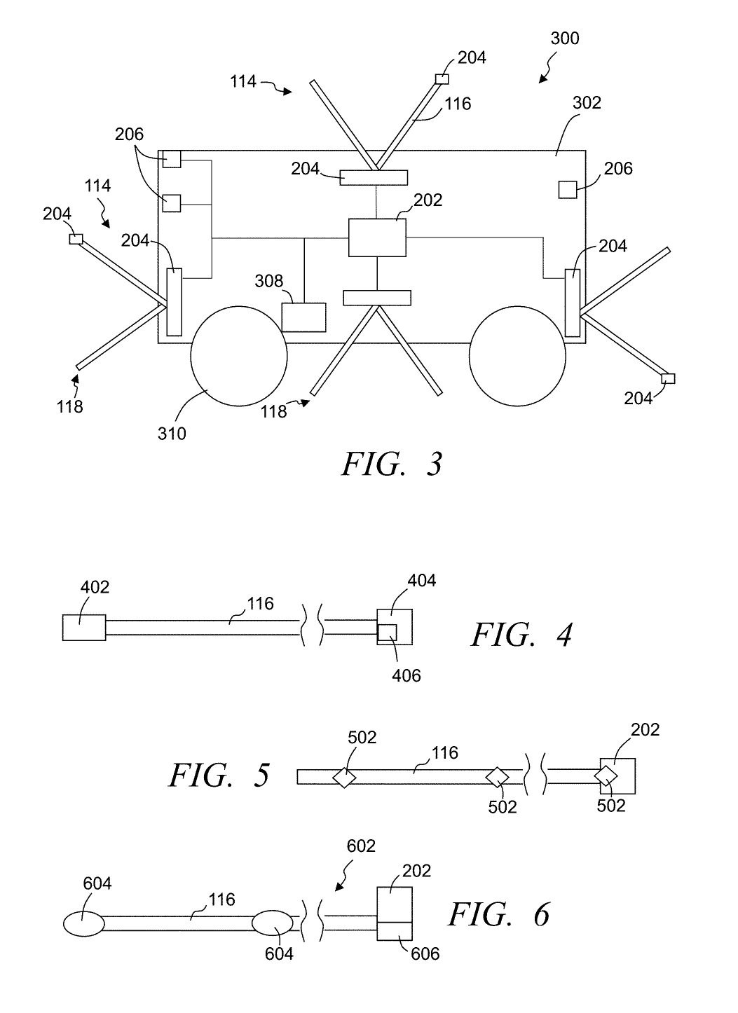

FIG. 3 illustrates a simplified block diagram of an exemplary unmanned ground vehicle (UGV) 300, in accordance with some embodiments. The UGV 300 includes a frame 302 or housing with one or more motors 308 secured with the frame and a plurality of wheels 310 or other movement devices (e.g., treads, tracks, etc.) configured to be driven by the one or more motors to allow movement of the UGV. The UGV further includes a vehicle control circuit 202 coupled with the one or more motors to control the motors and movement of the wheels. One or more of the motors provides forward and backward movement of the UGV, while one or more other motors control steering of the UGV.

The UGV 300 further includes an array of a plurality of tactile sensor systems 114 cooperated with the frame 302. At least some of the tactile sensor systems 114 include an extended feeler antenna 116 extending from the frame 302. In some implementations, one or more of the extended feeler antennae are positioned with an exterior or distal end 118 positioned to be proximate at least one of the wheels 310 and spaced from the frame 302. Other extended feeler antennae 116 may be positioned relative to intended directions of travel (e.g., one or more extended feeler antennae positioned near a front, a rear, lateral sides), and/or positioned relative to a top and/or bottom of the UGV 300. In some embodiments, one or more of the tactile sensor systems 114 further include at least one contact sensor 204 cooperated with the extended feeler antenna 116. Some extended feeler antenna 116 are cooperated with contact sensors 204 that are cooperated with the frame 102. Further, some extended feeler antenna 116 may include one or more contact sensors 204, such as contact sensors secured proximate the distal ends 118. Some embodiments additionally or alternatively include one or more contact sensors 204 separate from the extended feeler antennae and configured to detect contact by one or more of the feeler antennae with an external object. Typically, at least some of the extended feeler antennae 116 of the plurality of sensor systems are spaced around the frame and define at least outer most lateral perimeter points laterally spaced about the UGV 300.

The UGV 300 further includes one or more package carrier systems, compartments or the like configured to receive one or more packages while being transported by the UGV 300. Further, the package carrier system may include one or more package control systems 212 that enables control over the release, opening of a door, unlocking, and/or other controls over the package carrier system and the package. In some implementations, the package control system is positioned within the frame 302 and coupled with one or more motors to control one or more doors, locks, ramps, and the like of the UGV.

Other embodiments utilize other unmanned vehicles, such as but not limited to water vehicles, blimp type vehicles, and/or other relevant vehicles that can be utilized in delivering products and/or performing other retail tasks for one or more retailers and/or delivery services. These other types of unmanned vehicles can also include tactile sensor systems 114 with the extended feeler antenna 116. The below is described with reference to the unmanned aerial vehicle (UAV) 100 unless otherwise noted or understood through the context. It will be appreciated, however, that some or all of the description applies to other types of unmanned vehicles utilized in delivering packages.

In some embodiments, some or all of the extended feeler antennae 116 are elastic and/or flexible and configured to flex in response to a threshold pressure or force from contact with an external object that is external to the UAV 100. The threshold pressure is predefined and is dependent on the material used in constructing the extended feeler antennae, the dimensions of the extended feeler antennae, how the extended feeler antenna are secured with the frame 102 and/or other such factors. In some implementations, one or more extended feeler antennae have a longitudinal body configured to deflect in response to contact and exert an increasing opposing force as a function of the amount of deflection within a deflection threshold. The extended feeler antennae, for example, can be constructed of a material and with a known dimension to achieve a desired degree of flexibility to achieve a desired quantity of flex in response to a predefined or threshold pressure in a known direction, while further providing a desired return force due to the elasticity of the extended feeler antennae. The feeler antennae may be formed from plastic, aluminum, steel, carbon, other such material or combination of two or more of such material that provide the desired flexibility while also providing the desired rigidity. Additionally or alternatively, one or more of the extended feeler antennae may include a flexing structures, such as one or more springs, different materials, thinner and thicker portions, other such structures or combination of two or more of such structures. Such desired flexibility and rigidity can depend, for example, on the intended implementation of the UAV, the speeds at which the extended feeler antennae are expected to provide protection for the UAV, the mass of the UAV, the mass of packages expected to be carried by the UAV, and/or other such factors. In some embodiments, one or more of the extended feeler antennae include one or more contact sensors incorporated into and/or secured with the extended feeler antenna and/or a portion of a contact sensor is incorporated into and/or secured with the extended feeler antenna.

The UAV typically includes one or more other sensor systems 206. These sensor systems may work cooperatively with the tactile sensor systems 114 and/or operate independent with the tactile sensor systems. For example, in some applications, the UAV may include one or more cameras, altimeters, velocity/speed sensors, distance sensors (e.g., laser sensor systems), inertial sensor systems, accelerometers, sonar sensor systems, other such sensor systems, or combination of two or more of such sensor systems. The one or more sensor systems typically couple with the vehicle control circuit 202 providing sensor data that can be utilized by the vehicle control circuit in controlling the UAV and/or communicated to a remote system, such as a remote central control system, a remote routing system and/or other such remote systems. The UAV 100 further includes one or more wireless and/or wired communication transceivers configured to communicate with the one or more remote external systems. Further, the UAV may include a landing system or landing gear (not illustrated) that is part of or secured with the frame 102 and/or housing 104.

In some embodiments, one or more contact sensors 204 comprise pressure sensors. Such pressure sensors may be cooperated with the frame 102 or housing. In many implementations, each of one or more extended feeler antennae is cooperated with one or more pressure sensors position adjacent to or about the corresponding extended feeler antennae. In some embodiments, ends of one or more extended feeler antennae are in contact with one or more pressure sensors. Accordingly, in response to contact by the extended feeler antenna with an external object and/or deflection of the extended feeler antenna, the one or more pressure sensors detect the contact. The pressure sensors communicatively couple with the vehicle control circuit and/or other control circuits to communicate pressure sensor data. Such pressure sensor data can be evaluated relative to one or more threshold pressures and one or more actions initiated in response to detected pressure having a predefined relationship with one or more threshold pressures.

FIG. 4 illustrates a simplified block diagram of an exemplary tactile sensor system 114 with an exemplary extended feeler antenna 116, in accordance with some embodiments. As introduced above, one or more of the extended feeler antennae 116 may include one or more contact sensors and/or a portion of a contact sensor incorporated into and/or secured with the extended feeler antenna. In some embodiments, each of a set of multiple extended feeler antennae 116 include an electrically conductive contact pad 402 exposed on an exterior surface of at least a portion of the extended feeler antenna 116. One or more conductive contact pads 402 may be positioned along one or more portions of the length of the extended feeler antenna. Further, one or more electrical charge storage systems 404 are electrically coupled with each of the conductive contact pads 402. In some implementations, each of a set of multiple contact sensors 204 of the plurality of contact sensors includes a charge storage system 404 that electrically couple with one or more of the conductive contact pads 402 and configured to store electrical energy. Additionally, in some applications, the charge storage system 404 stores over time accumulated electrical energy from static electricity. For example, as the unmanned vehicle travels static electricity may be generated by the contact pads 402 that is electrically conducted to the charge storage system 404. In some implementations, the charge storage system 404 may include a stored electrical charge (e.g., battery) and/or may be electrically coupled with a separate electrical source (e.g., a battery of the unmanned vehicle).

Further, the charge storage system 404 is further configured to discharge stored electrical charge through the one or more contact pads 402 in response to contact with an external object that can pull electrical charge (e.g., human, dog, car, plant, etc.). The tactile sensor systems 114 can further include a discharge sensor 406 configured to detect a discharge of electricity from the charge storage system 404, which typically occurs in response to contact by a corresponding one of the contact pads 402 with the external object. In some embodiments, the discharge sensor coupled with the vehicle control circuit 202 and notifies the vehicle control circuit of the detected discharge indicating contact by one or more of the extended feeler antennae with an external object, which allows the vehicle control circuit to take one or more action. The discharge sensor and/or the vehicle control circuit (or other processing system) can evaluate the discharge relative to one or more predefined discharge thresholds corresponding to a sufficient discharge of electrical energy that would be expected in response to contacting one or more types of objects. The consideration of the one or more thresholds can be utilized to limit false contact detections and false responses. In some instances, the discharge thresholds may correspond to threshold pressures of contact. Often the action initiated by the vehicle control circuit is based on which extended feeler antennae contacted the object. For example, in some instances, the vehicle control circuit 202 directs one or more motors 108 to adjust rotational speed of a corresponding propeller 110 to cause a rapid response to move the unmanned vehicle away from the object contacted. Such actions may additionally or alternatively cause the unmanned vehicle to tilt away from the contact. Further, as described above and further below, the extended feeler antennae may be constructed with an elasticity such that those extended feeler antennae resist further movement toward the object (e.g., gradually increasing in force pushing away from the object as the unmanned vehicle moves toward the object), and in some instances may induce a force away from the object further pushing the unmanned vehicle away from the object as the vehicle control circuit also takes action based on the detected contact with the external object.

FIG. 5 illustrates a simplified cross-sectional, block diagram of an exemplary tactile sensor system 114 with an inertial sensor 502, in accordance with some embodiments. Some embodiments additionally or alternatively utilize one or more inertial sensors 502 to detect contact with an external object. In some implementations, for example, each of a set of multiple extended feeler antennae 116 of the plurality of feeler antennae include one or more an inertial sensors 502 positioned proximate the distal end 118 and/or along a length of the respective extended feeler antenna as a contact sensor 204 or a portion of a contact sensor. The inertial sensors include a processing system and/or are communicatively couple with the vehicle control circuit 202 or other control circuit. The inertial sensors are configured to communicate contact sensor data comprising inertia data to the vehicle control circuit or other control circuit. Typically, the contact of the extended feeler antenna (e.g., at the distal end 118 of the extended feeler antenna) with an external object would result in a relatively rapid change in inertia and/or acceleration (e.g., instant stop or drastic reduction in move, rapid movement in a different direction in response to a flexing of a portion of the extended feeler antenna, etc.). Such changes in inertia or acceleration can be evaluated relative to one or more predefined inertial thresholds as a test or confirmation of contact with an external object. In some instances, the inertial thresholds correspond to and/or are mapped to predefined threshold pressures of contact. Based on the inertial data the vehicle control circuit 202 and/or other control circuit can be configured make a determination that there has been contact with an external object. Again, this determination may be based on identifying from the inertial data a threshold inertia change of at least a portion of at least one of the extended feeler antennae 116 of the set of multiple extended feeler antennae.

Some embodiments additionally or alternatively include one or more inertial sensors that are separate from the extended feeler antennae 116. For example, one or more inertial sensors may be secured within the housing 104 and coupled with the vehicle control circuit 202. The vehicle control circuit has knowledge of the dimensions of the unmanned vehicle. Using dimensions information of the unmanned vehicle, direction of travel and detected inertial sensor data from one or more inertial sensors within the housing, the vehicle control circuit can use the inertial sensor data to determine from what angle and direction the unmanned vehicle contacted an external object based on trajectory changes, accounting for the continued thrust in the intended direction. For example, upon contacting a wall head-on and at a relatively slow speed to avoid damage, the vehicle control circuit can halt forward movement upon detection of the contact and with some potential cushion effect depending on the antenna design. Test probing may be implemented by slowly repeating a motion obtaining similar sensor data results as the obstacle is contacted. Further, the unmanned vehicle may bounce at an angle or be somewhat turned with a bounce or travel flat along a flat obstacle such as a wall, with corresponding inertial sensor data indicating such movements in response to the contact with the external object. As such, inertial sensor data can be obtained from inertial sensors incorporated with the extended feeler antennae and/or separate from the extended feeler antennae and the tactile sensor systems. The inertial data will indicate the contact with an obstacle, and such inertial sensor data may be paired with other sensors on the antennae that provide an overall interpretation of the obstacle encounter (e.g., as video or the tactile sensors).

FIG. 6 illustrates a simplified cross-sectional, block diagram of an exemplary tactile sensor system 114 with a temperature change detection system 602, in accordance with some embodiments. Some embodiments additionally or alternatively include one or more temperature change detection systems 602 coupled with a temperature conductive surface 604 exposed on an exterior surface of each of a set of multiple extended feeler antennae of the plurality of extended feeler antennae, wherein the temperature change detection system is configured to detect a threshold change in temperature from at least one of the temperature conductive surfaces within a threshold period. In some instances, the threshold changes in temperature correspond to and/or are mapped to predefined threshold pressures of contact. The temperature control systems couple with the vehicle control circuit 202 and are configured to communicate temperature change sensor data to the vehicle control circuit. Using the temperature change sensor data, the vehicle control circuit is configured make a determination that there has been contact with the external object based on the temperature change sensor data. The temperature change sensor data may be actual temperature data that is evaluated by the vehicle control circuit 202, a notification that a threshold change in temperature is detected by a temperature system control circuit, or other such relevant data. In some embodiments, the temperature change detection system 602 includes one or more temperature source systems 606 that alter the temperature of one or more temperature conductive surfaces 604 to enable the change in temperature from the altered temperature in response to a detected temperature change from that altered temperature. For example, the temperature of the one or more temperature conductive surfaces 604 may be altered to a temperature that is cooler than an environment temperature. Contact with an object would result in a change based on a difference in temperature between the temperature conductive surface 604 and the object contacted. As a further example, contact of a cooled temperature conductive surface with a car or other surface sitting in the sun would result in rapid change in temperature of the temperature conductive surface that is detected by the vehicle control circuit 202 or temperature change detection control circuit of the temperature change detection system 602. Alternatively, the altered temperature may be higher than an environment temperature. The altered temperature may be selected based on an environment temperature to aid in a more rapid detection of temperature change resulting from contact.

As described above, the vehicle control circuit 202 or other control circuit can initiate one or more actions in response to the detection of contact by one or more of the extended feeler antennae with an external object. In some embodiments, for example, the vehicle control circuit is configured to receive contact sensor data from one or more contact sensors each cooperated with an extended feeler antenna in response to the corresponding extended feeler antenna contacting an external object. Based on the sensor data the vehicle control circuit identifies one or more propellers 110 that are positioned closest to the one or more extended feeler antennae that are determined to have contacted the external object. Using the identified propellers, the vehicle control circuit can induce an evasive increase in rotational speed of the one or more propellers in response to contact sensor data indicating contact of the one or more extended feeler antennae with the external object. Further, this increased rotational speed of the one or more propeller can occur while not increasing rotational speed of one or more of the other of the plurality of propellers, and/or decreasing rotational speed of one or more other propellers. The variation in rotational speed of different propellers can cause at least a portion of the unmanned aerial vehicle proximate the identified propeller corresponding to the one or more extended feeler antennae that contacted the external object to move away from the contact and the object (e.g., a rapid rise and tilt of a portion of the aerial vehicle).

In other implementations, one or more of the tactile sensor systems 114 may couple with or include one or more motor controllers 224. These motor controllers can be configured to control one or more of the plurality of motors 108. In some embodiments, each of the plurality of motor controllers 224 is directly communicatively coupled with at least one of the contact sensors 204 and configured to receive sensor data from the at least one contact sensor corresponding to one of the propellers controlled by that motor controller 224. In response to a trigger from the contact system, the motor controllers can be configured to immediately adjust (i.e., without further input or instructions from the vehicle control circuit 202 or other input) a corresponding motor 108 to induce an evasive change in rotational speed of a corresponding propeller in response to the received contact sensor data indicating contact with the external object by one or more extended feeler antennae corresponding to the contact sensor. Typically, the motor controller 224 causes the change in propeller rotational speed of one propeller while not increasing rotational speed of one or more of the other of the plurality of propellers. Because of the differences in rotational speed between different propellers, the change in rotational speed can cause at least a portion of the unmanned aerial vehicle proximate the first propeller to move away from the contact.

In some embodiments, one or more imaging systems may be cooperated with one or more of the extended feeler antennae. The extended feeler antenna may be formed of an optical fiber, may include one or more optical fibers, may include one or more lenses and the like, which cooperate with an imaging system mounted in the housing 104 and/or on the frame 102. Accordingly, images can be captured relative to the distal ends of the extended feeler antenna. The image data can be processed by the vehicle control circuit and/or other control circuits (e.g., a remote system) to preform image processing. Based on this image processing the vehicle control circuit may identify potential contact and/or contact with an object. Typically, such imaging is utilized with one or more other types of sensor data (e.g., pressure sensor data, electrical discharge data, temperature change data, other such sensor data, or combination of two or more of such data).

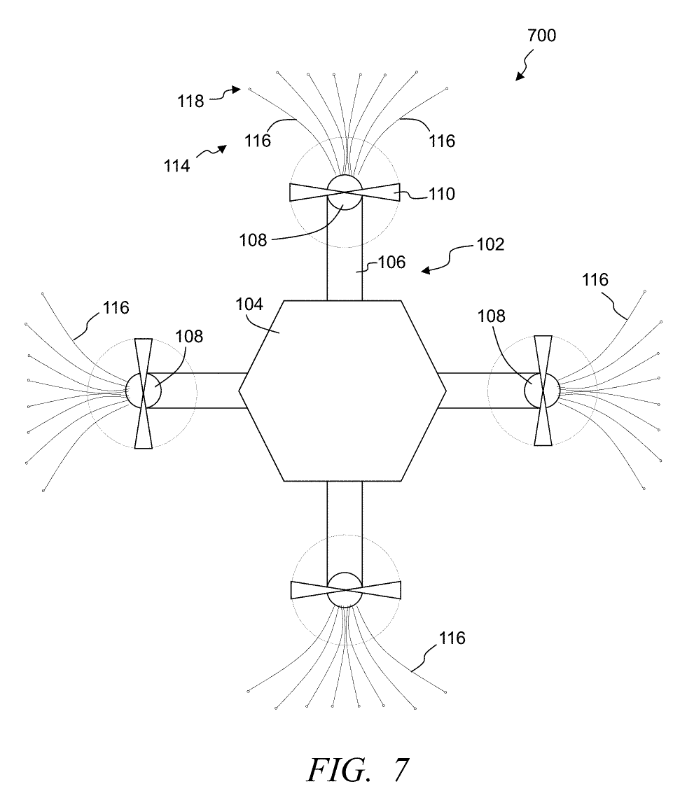

As introduced above, the extended feeler antennae 116 can be implemented in various configurations and/or different types of antennae. For example, some embodiments use relatively thin and flexible extended feeler antennae. Other embodiments may utilize more rigid and/or thicker extended feeler antennae. The dimensions, flexibility, rigidity, and other physical aspects of the extended feeler antennae can be selected based on one or more factors, such as but not limited to type of unmanned vehicle, size and/or weight of the unmanned vehicle, expected speeds of the unmanned vehicle and/or expected speeds when taking advantage of the extended feeler antennae and corresponding sensor data, intended responses, desire for the extended feeler antennae to act as a bumper and/or provide some elastic push away from the contact, and/or other such factors. FIG. 7 illustrates a simplified overhead view of an exemplary unmanned vehicle 700, in accordance with some embodiments. The unmanned vehicle 700 includes multiple sets of extended feeler antennae 116 that are relatively thin and light weight, and are flexible, much like cat whiskers. Such a configuration of sets of extended feeler antennae may be advantageous for unmanned aerial vehicles and other unmanned vehicles where weight and/or wind resistance may adversely affect the unmanned vehicle and/or the capabilities of the vehicle to perform the deliveries and/or other relevant tasks. In some instances, the extended feeler antennae may be formed with one or more optic fibers and can carry reflected light to one or more light sensors of the tactile sensor systems 114, which can determine the approach of an external object based on reflected light. The reflected light may be light emitted by one or more optic fibers of the extended feeler antennae. One or more of the light weight extended feeler antenna may be formed of a plastic and bend relatively easily, while the bending is detected by induced pressure on one or more pressure sensors of the tactile sensor systems 114, and/or a change in light transmitted along the plastic light weight extended feeler antenna.

Some embodiments additionally or alternatively utilize more rigid extended feeler antennae. For example, ground based and/or water based vehicles may utilize more rigid and/or heavier extended feeler antennae where weight is not as critical a factor as aerial vehicles. Often ground vehicles are heavier. Accordingly, the extended feeler antennae can be constructed of more rigid configurations to withstand greater forces of impact (e.g., due to the added weight). Further, the weight of the tactile sensor systems may not be as critical to non-aerial vehicles. Accordingly, unmanned ground vehicles, water vehicles and the like may utilize antenna motors or additional antenna motors to sweep or otherwise move the extended feeler antennae, retract telescoping versions of extended feeler antennae, incorporate cameras and/or lenses at the distal ends 118 of extended feeler antennae, and/or other such options. The placement of the extended feeler antennae with unmanned ground and water vehicles may be different than for aerial vehicles (e.g., front and rear may have more sturdy extended feeler antennae based on directions of travel). Additionally, the extended feeler antennae with an unmanned ground vehicle may be more elastic or provide more give because the ground vehicle has less inherent give than unmanned aerial and/or water vehicles as a result of the contact with the ground. Similarly, unmanned water vehicles may include one or more extended feeler antennae that extend below the vehicle to detect depth and/or potential contact with something underneath the unmanned water vehicle.

Some extended feeler antennae are secured with the frame 102 and/or housing 104 in such a way to be readily detachable when a threshold force away from the frame and/or housing is exerted on the extended feeler antenna. In some embodiments, for example, the housing 104 and/or frame 102 includes a detach coupling configured to cause at least a portion of the extended feeler antenna to detach from the frame in response to a threshold pull force applied to the extended feeler antenna that is directed away from the frame. Such a detachable coupling provides added protection for the unmanned vehicle. Should a person or animal get a hold of one or more of the extended feeler antennae, the detachable coupling allows the unmanned vehicle to get away from the person or animal without or minimal damage to the unmanned vehicle, while leaving the one or more extended feeler antennae or portions of the extended feeler antennae that were held/gripped by the person or animal. Similarly, should an antenna get stuck in or to an external object contacted by the antenna, the detachable coupling allows the unmanned vehicle to get away from the object. In some instances, one or more of the extended feeler antennae are formed from segments along the length, with one or more of those segments having detachable couplings with other segments allowing a detachment of a portion of the extended feeler antenna. Accordingly, one or more segments of an extended feeler antenna may detach while a portion of the extended feeler antenna remains secured with the unmanned vehicle. The detachable coupling may be through friction or pressure fit, tongue and groove, snap fit, and/or other such coupling.

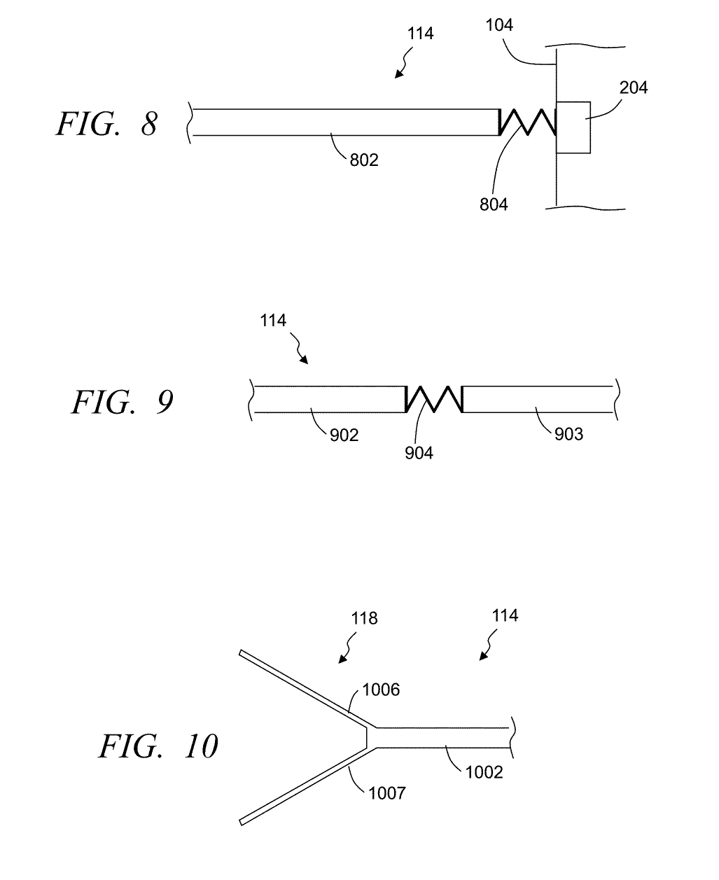

One or more of the extended feeler antennae 116 may further include one or more flexing structures to allow and/or enhance bending and/or flexing of the extended feeler antennae. FIG. 8 illustrates a simplified block diagram of a portion of an extended feeler antenna 116 secured with the housing 104, in accordance with some embodiments. The extended feeler antennae includes a longitudinal body 802 extending away from the housing 104 and/or frame 102 of the unmanned vehicle. One or more spring members 804 are cooperated with the longitudinal body 802. In some implementations, the spring member 804 is cooperated between the longitudinal body 802 and the housing 104 of the unmanned vehicle. The spring member 804 is configured to flex, compress and/or deflect in response to the longitudinal body contacting an external object enabling at least a portion of the flexing of the extended feeler antenna.

FIG. 9 illustrates a simplified block diagram of a portion of an extended feeler antenna 116 having a spring member 904 secured between two longitudinal bodies or body sections 902-903, in accordance with some embodiments. The spring member 904 is configured to flex, compress and/or deflect in response to the extended feeler antenna contacting an external object enabling at least a portion of the flexing of the extended feeler antenna. Although only a single spring member is illustrated in FIGS. 8-9, a single extended feeler antenna may include multiple spring members and/or different kinds of spring members. The spring members can be substantially any relevant type of spring device or flexible structure, such as but not limited to coiled spring, cantilever, volute spring, leaf spring, torsion spring, or other such springs.

In some embodiments, one or more of the extended feeler antennae may have various structures and/or configurations, which may for example enhance the volume about the unmanned vehicle covered by the extended feeler antennae, enhance flexibility, enhance rigidity, enhance durability, and/or other such variations. FIG. 10 illustrates a simplified block diagram of an exemplary distal end 118 portion of an exemplary extended feeler antenna 116, in accordance with some embodiments. In this embodiment, the extended feeler antenna includes multiple prong sections 1006-1007 positioned proximate to or at the distal end 118 of the extended feeler antenna. Accordingly, the pronged sections are configured to be positioned about a corresponding one of the propellers proximate the respective extended feeler antenna. The increased width of the distal end 118 of the extended feeler antenna provides an enhanced volume over which the extended feeler antenna probes and/or protects the corresponding propeller. Further, the increased volume covered by the prong sections is achieved with reduced numbers of extended feeler antennae that would otherwise need to be employed. The width separating the prong sections can be substantially any width to provide the desired coverage provided by the extended feeler antennae. Similarly, the extended feeler antennae can have substantially any relevant number of prong sections. Still further, in some embodiments, the prong sections have reduced thickness relative to the longitudinal body 1002 which may allow for greater flexibility than the longitudinal body. This greater flexibility can provide an enhanced cushioning of initial contact with the external object providing additional protection for the unmanned vehicle and the extended feeler antenna. Still further, the enhanced cushioning provides improved control and performance of the unmanned vehicle based on improved control of the unmanned vehicle. Further, in some embodiments, one or more prong sections or sub-antenna sections may extend from the longitudinal body 1002 at one or more locations along the length of the longitudinal body, which can provide similar enhancements as the prong sections at the distal end.

Referring to FIGS. 1-3, in some embodiments, one or more of the tactile sensor systems 114 include one or more antenna motors 228 each cooperated with one or more of the extended feeler antennae 116. The antenna motors 228 is communicatively coupled with the vehicle control circuit 202, or with one or more other control circuits (e.g., motor controller 224). The vehicle control circuit 202 or other control circuit can be configured to control the plurality of antenna motors to cause a change of position of the corresponding extended feeler antennae 116 relative to the frame 102. In some embodiments, for example, the vehicle control circuit 202 is configured to control the plurality of antenna motors 228 to cause a distal end 118 of each of the plurality of extended feeler antennae 116 to repeatedly sweep along a movement path proximate a corresponding one of the plurality of propellers. This sweeping increases the volume of area of protection provided by the extended feeler antennae and/or reduces the number of extended feeler antennae utilized with an unmanned vehicle. In some instances, the antenna motors 228 are operated while the unmanned vehicle is traveling less than a threshold speed. Additionally or alternatively, in some embodiments the vehicle control circuit 202 is configured to identify a direction of travel of the unmanned vehicle 100 and to control one or more of the plurality of antenna motors 228 to position one or more of the extended feeler antennae 116 to align with the direction of travel. For example, one or more extended feeler antennae are moved to point away from a direction of travel when the unmanned vehicle is traveling at greater than a threshold velocity to reduce wind drag and/or reduce wear on the extended feeler antennae and other structures of the unmanned vehicle supporting the extended feeler antennae.

Further, in some embodiments, one or more of the feeler antennae include one or more hinges or other structures to allow bending between two longitudinal body sections (e.g., sections 902-903). One of the plurality of antenna motors can be configured to cause the extended feeler antenna to bend at the hinge and extend at the hinge. In some instances, the two longitudinal body sections may be spring biased in the closed or open position and the antenna motor overcomes the biasing. The vehicle control circuit 202 can be configured to control the antenna motor 228 in response to a direction of travel of the unmanned vehicle 100 and a speed of the unmanned vehicle exceeding a speed threshold. As described above, some embodiments include one or more other sensor systems 206 that can be utilized in cooperation with and/or in addition to the tactile sensor systems 114. Some unmanned vehicles may further include one or more additional proximity sensors that couple with the vehicle control circuit 202 and are configured to communicate proximity sensor data to the vehicle control circuit. Such proximity sensors may include laser distance detection systems, sonar systems, cameras and image and/or video processing systems, other such proximity sensors or combination of two or more of such proximity sensors. The vehicle control circuit can be configured to control the propeller motors 108 and/or one or more antenna motors 228 based on the contact sensors 204 and/or the other proximity sensors. In some instances, for example, the vehicle control circuit can control one or more antenna motors to move a distal end 118 of one or more extended feeler antennae 116 cooperated with the one or more antenna motors relative to corresponding propellers based on the proximity sensor data. This can include extending or elongating one or more extended feeler antennae, retracting or bending one or more extended feeler antennae, or the like. Further, in some embodiments, the vehicle control circuit 202 can be configured to detect a speed of the unmanned vehicle 100 and identify when the speed is greater than one or more speed thresholds in a given direction, and cause one or more of the plurality of extended feeler antennae to be put in a stowed position (e.g., moved to be against a portion of the housing 104, moved to be angled away from a direction of travel, partially or fully retracted, etc.) as a function of the first direction and in response to the speed of the unmanned aerial vehicle being greater than the speed threshold. Similarly, the vehicle control circuit may control one or more antenna motors to move one or more extended feeler antennae based on the speed of the unmanned vehicle exceeding or falling below one or more speed thresholds (e.g., move extended feeler antennae to predefined locations based on the threshold speed to provide protection for potential hazards while traveling at that speed relative to potential hazards expected while traveling at different speeds, and/or other such movement of the one or more extended feeler antenna, or the like).

The unmanned vehicles 100, 300, 700 are utilized in performing deliveries of packages and/or other tasks. Accordingly, the unmanned vehicles are typically part of a delivery system and/or retail system. These delivery systems coordinate multiple unmanned vehicles in providing unmanned deliveries and/or transporting packages.

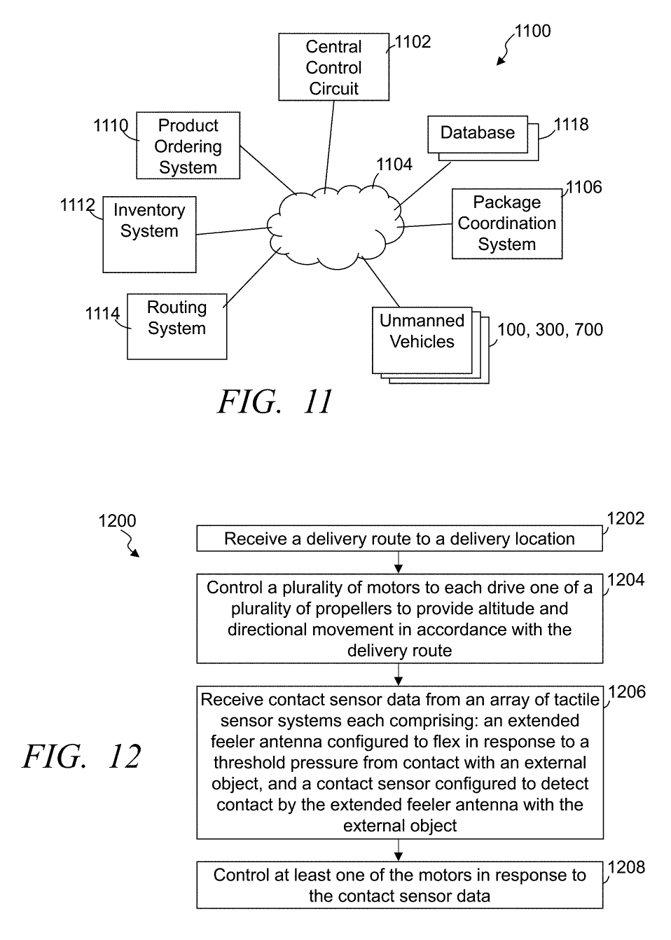

FIG. 11 illustrates a simplified block diagram of an exemplary unmanned vehicle delivery system 1100 or other such unmanned vehicle coordination system, in accordance with some embodiments. The system 1100 includes the multiple unmanned vehicles 100, 300, 700, which can be unmanned aerial vehicles, ground vehicles, water vehicles, and/or other such vehicles. One or more central control circuits 1102 or systems are communicatively coupled with the unmanned vehicles through one or more distributed communication and/or computer networks 1104. Some embodiments include one or more package coordination systems 1106 configured to receive requests for package delivery, retrieval locations, and delivery locations, and coordinates the scheduling of the deliveries based on one or more factors (e.g., inventory, availability of the product or package, numbers of unmanned vehicles, other deliveries to be scheduled and/or already scheduled, retrieval locations, delivery locations, locations of unmanned vehicles, other such factors, and typically a combination of two or more of such factors).

Some embodiments include one or more product ordering systems 1110 that is configured to receive orders for products from one or more customers (e.g., via corresponding customer computers, smartphones, tablets, etc.), retail stores, and/or other such sources. The system may provide access to inventory information and allow a customer and/or retail worker to order quantities of one or more products. Further, the delivery system 1100 typically further includes an inventory system 1112 that tracks inventory of products at one or more distribution centers, fulfillment centers, retail stores or the like. The inventory system can adjust inventory levels of tens or hundreds of thousands of different products as they move into and out of distribution centers, fulfillment centers, retail stores, transfer facilities, and/or other such facilities. In some embodiments, the delivery system 1100 further includes one or more routing systems 1114 configured to determine routes that at least the unmanned vehicles are to follow between a package retrieval location (i.e., where the package is cooperated with the unmanned vehicle) to a delivery location, which may include one or more intermediary locations and/or other delivery locations. The routing system 1114 evaluates the various routes and selects an optimized route based on the type of one or more unmanned vehicles intended to be used in delivering the package, the weight of the package, the capabilities of the delivery vehicles and other such factors. In some instances, the routing system further considers traffic conditions, restricted travel areas (e.g., no-fly-zones, road work, government and/or military facilities, airports, etc.). The delivery system 1100 typically further includes one or more databases 1118 communicatively coupled with the central control circuit and configured to store relevant information to be accessed by at least the central control circuit, and in some instances one or more of the package coordination system 1106, product ordering system 1110, inventory system 1112, routing system 1114, unmanned vehicles 100, and/or other such systems. The databases 1118 may store, for example, customer information (e.g., address, payment methods, etc.), facility addresses, historical data, delivery restrictions, delivery preferences, vehicle capabilities, and/or other such information. In some embodiments, the central control circuit controls the distribution of the unmanned vehicles based on the scheduling from the package coordination system 1106.

FIG. 12 illustrates a simplified flow diagram of an exemplary process of delivering retail products and packages using a retail delivery unmanned aerial vehicle and/or performing other retail tasks, in accordance with some embodiments. In step 1202, a delivery route to a delivery location is received by a vehicle control circuit 202 of a retail delivery unmanned vehicle 100. In step 1204, one or more motors 108, 308 are controlled to implement and control movement of the unmanned vehicle. For example, in some embodiments one or more motors 108 each cooperated with the frame 102 of the unmanned aerial vehicle 100 are controlled to each drive one of a plurality of propellers 110 to provide and/or control altitude and directional movement of the unmanned aerial vehicle in accordance with the delivery route.

In step 1206, contact sensor data is received at the vehicle control circuit 202 from one or more of an array of a plurality of tactile sensor systems 114. In some embodiments, one or more of the tactile sensor systems comprise one or more extended feeler antennae 116 and one or more contact sensors 204 that each cooperate with one or more of the extended feeler antennae. Further, in some implementations, the extended feeler antennae extend from the frame 102 with a distal end 118 proximate one of the propellers 110 and are spaced from the frame. The extended feeler antenna is typically configured to flex in response to a threshold pressure from contact with an external object. The contact sensors are cooperated with at least one extended feeler antenna and are configured to detect contact by the extended feeler antenna with the external object. Further, the extended feeler antennae 116 of the plurality of tactile sensor systems 114 are spaced around the frame 102 and define at least outer most lateral perimeter points laterally spaced about the unmanned aerial vehicle.

In step 1208, one or more of the motors 108 are controlled in response to the contact sensor data As described above, the actions taken by the vehicle control circuit 202 or other control circuit (e.g., motor controller 224) can include increasing and/or decreasing propeller speeds of one or more propellers 110, causing the unmanned vehicle to turn, causing the unmanned vehicle to revise direction, causing the unmanned vehicle to tile, causing the unmanned vehicle to increase or decrease altitude, other such actions or a combination of two or more of such actions. In some embodiments, the contact sensor data is received from a contact sensor cooperated with a particular extended feeler antenna in response to the particular extended feeler antenna contacting the external object, and a propeller that is positioned closest to that particular extended feeler antenna is identified. In controlling one or more of the motors in response to the contact sensor data can include inducing an evasive increase in rotational speed of the identified propeller in response to the contact sensor data indicating contact of the particular extended feeler antenna with the external object. This increase in rotational speed may occur while not increasing rotational speed of one or more of the other of the plurality of propellers to cause at least a portion of the unmanned aerial vehicle proximate the identified propeller to rapidly move away from the contact and the object. The response time of the unmanned vehicle may be dependent on the type of contact, the object contacted, the type of contact sensor data being evaluated and the like. Typically, the response is less than a second and in most instances less than half a second. The response may be slowed in some instances, such as when the unmanned vehicle is moving slowly and the contact sensor data is quantified to a relatively light contact (e.g., based on pressure sensor data). By slowing the response time the vehicle control circuit 202 and/or other control circuit can process additional contact sensor data and/or other sensor data to confirm contact and determine an appropriate action.

Some embodiments control one or more of a plurality of antenna motors 228 to cause a change of position of the extended feeler antennae 116 relative to the frame 102. This change of position can include, in some applications and/or during some operational conditions, to control the plurality of antenna motors 228 to cause a distal end 118 of each of the plurality of extended feeler antennae 116 to repeatedly sweep along one or more movement paths proximate a corresponding one of the plurality of propellers 110. Additionally or alternatively, some embodiments, in control the plurality of antenna motors, identify a direction of travel of the unmanned vehicle and control one or more of the plurality of antenna motors to position one or more of the extended feeler antennae 116 to align with the direction of travel. Some embodiments control an antenna motor of the plurality of antenna motors to cause at least one corresponding extended feeler antenna 116 to bend at a hinge of the extended feeler antenna in response to a direction of travel of the unmanned vehicle and a speed of the unmanned vehicle exceeding a speed threshold. Other sensor data may additionally or alternatively be used in controller the unmanned vehicle. In some implementations, proximity sensor data is obtained from one or more additional proximity sensors of the unmanned vehicle. The control of one or more antenna motors can include controlling at least one antenna motor of the plurality of antenna motors to move a distal end 118 of a particular extended feeler antenna 116 cooperated with a corresponding antenna motor relative to a corresponding propeller based on the proximity sensor data. The proximity sensor data may be distance data, image data and/or other relevant data. The contact sensor data may include inertia data from at least one of a set of multiple extended feeler antennae of the plurality of feeler antennae that is received by the vehicle control circuit 202, one or more the motor controllers 224 and/or other control circuits. One or more inertial sensors may be positioned proximate distal ends 118 of respective extended feeler antennae. The inertial data can be evaluated to identify, from the inertial data, a threshold inertia change of at least a portion of at least one of the extended feeler antennae of the set of multiple extended feeler antennae. A determination can be made that there has been contact with the external object based on the identified threshold inertia change of at least the portion of the at least one of the extended feeler antennae. Additionally or alternatively, in some embodiments one or more inertial sensors are maintained within the housing 104 and/or secured with the frame 102. Inertial sensor data from these additional inertial sensors can be evaluated to detect when the unmanned vehicle contacts an object based on a threshold change in inertia, a change in inertial that corresponds with one or more predefined inertial change patterns, or the like.

Some embodiments store electrical energy accumulated over time from static electricity in an electrical charge storage system 404 of each of a set of multiple contact sensors 204 of the plurality of contact sensors. A discharge of at least some of the electrical charge stored in a corresponding one of the charge storage systems can be detected in response to contact of an electrically conductive contact pad 402, exposed on an exterior surface of a corresponding one of the plurality of extended feeler antennae 116, with the external object. In some embodiments a contact sensor control circuit or discharge sensor 406 is coupled with the charge storage system 404 and/or a conductive path to between the charge storage system and the conductive contact pad 402 to detect a discharge of some or all of the stored charge.

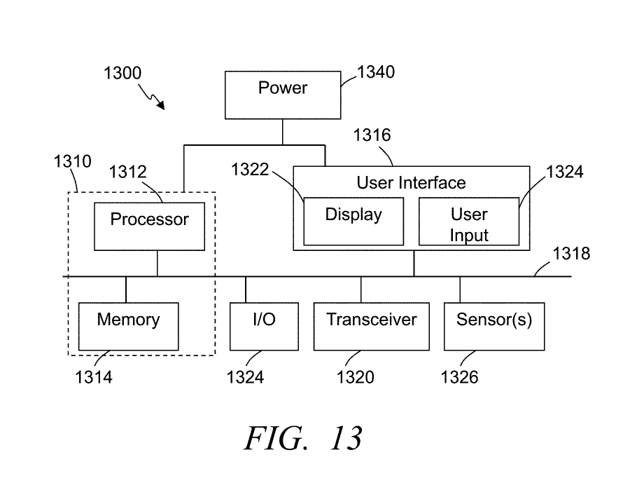

Further, the circuits, circuitry, systems, devices, processes, methods, techniques, functionality, services, servers, sources and the like described herein may be utilized, implemented and/or run on many different types of devices and/or systems. FIG. 13 illustrates an exemplary system 1300 that may be used for implementing any of the components, circuits, circuitry, systems, functionality, apparatuses, processes, or devices of the unmanned vehicles 100, 300, 700, the unmanned vehicle delivery system 1100 and/or other above or below mentioned systems or devices, or parts of such circuits, circuitry, functionality, systems, apparatuses, processes, or devices. For example, the system 1300 may be used to implement some or all of unmanned vehicles 100, 300, 700, the vehicle control circuit 202, the motor controller 224, the tactile sensor systems 114, the central control circuit 1102, and/or other such components, circuitry, functionality and/or devices. However, the use of the system 1300 or any portion thereof is certainly not required.

By way of example, the system 1300 may comprise a control circuit or processor module 1312, memory 1314, and one or more communication links, paths, buses or the like 1318. Some embodiments may include one or more user interfaces 1316, and/or one or more internal and/or external power sources or supplies 1340. The control circuit 1312 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1312 can be part of control circuitry and/or a control system 1310, which may be implemented through one or more processors with access to one or more memory 1314 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1300 may be used to implement one or more of the above or below, or parts of, components, circuits, systems, processes and the like.

The user interface 1316 can allow a user to interact with the system 1300 and receive information through the system. In some instances, the user interface 1316 includes a display 1322 and/or one or more user inputs 1324, such as buttons, touch screen, track ball, keyboard, mouse, etc., which can be part of or wired or wirelessly coupled with the system 1300. Typically, the system 1300 further includes one or more communication interfaces, ports, transceivers 1320 and the like allowing the system 1300 to communicate over a communication bus, a distributed computer and/or communication network 1104 (e.g., a local area network (LAN), the Internet, wide area network (WAN), etc.), communication link 1318, other networks or communication channels with other devices and/or other such communications or combination of two or more of such communication methods. Further the transceiver 1320 can be configured for wired, wireless, optical, fiber optical cable, satellite, or other such communication configurations or combinations of two or more of such communications. Some embodiments include one or more input/output (I/O) ports 1334 that allow one or more devices to couple with the system 1300. The I/O ports can be substantially any relevant port or combinations of ports, such as but not limited to USB, Ethernet, or other such ports. The I/O interface 1334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1326 to provide information to the system and/or sensor information that is communicated to another component. The sensors can include substantially any relevant sensor, such as pressure sensors, electrical discharge sensors, cameras or other imaging systems and image and/or video processing, temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1300 comprises an example of a control and/or processor-based system with the control circuit 1312. Again, the control circuit 1312 can be implemented through one or more processors, controllers, central processing units, logic, software and the like. Further, in some implementations the control circuit 1312 may provide multiprocessor functionality.

The memory 1314, which can be accessed by the control circuit 1312, typically includes one or more processor readable and/or computer readable media accessed by at least the control circuit 1312, and can include volatile and/or nonvolatile media, such as RAM, ROM, EEPROM, flash memory and/or other memory technology. Further, the memory 1314 is shown as internal to the control system 1310; however, the memory 1314 can be internal, external or a combination of internal and external memory. Similarly, some or all of the memory 1314 can be internal, external or a combination of internal and external memory of the control circuit 1312. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 610. The memory 1314 can store code, software, executables, scripts, data, content, lists, programming, programs, log or history data, user information, customer information, product information, route information, restricted area information, and the like. While FIG. 13 illustrates the various components being coupled together via a bus, it is understood that the various components may actually be coupled to the control circuit and/or one or more other components directly.

The use of unmanned vehicles can present potential problems based on potential contact of the unmanned vehicles with external objects. For example, propellers or rotors of an unmanned aerial vehicle can be dangerous to people, pets, property and the like, and similarly the propellers may be damaged by such external objects. One way to protect these external objects and/or the unmanned vehicles is to physically shroud the propellers and/or vehicles. Such shrouds, however, often diminish the performance of the propellers by interfering with optimal air flow, add weight, can be costly, and other such drawbacks. Another potential approach to addressing contact with an external object is a virtual shroud that would stop or disengage a motor and thus the corresponding propeller. The sudden loss of lift from the disengaged propeller, however, would draw the unmanned vehicle into the external object instead of away from it. Other sense and avoid systems have focused on visual signals in visible and invisible spectrum. Interference with visual sensing can be experienced due to weather, other objects, failure of the imaging system, and other such factors.

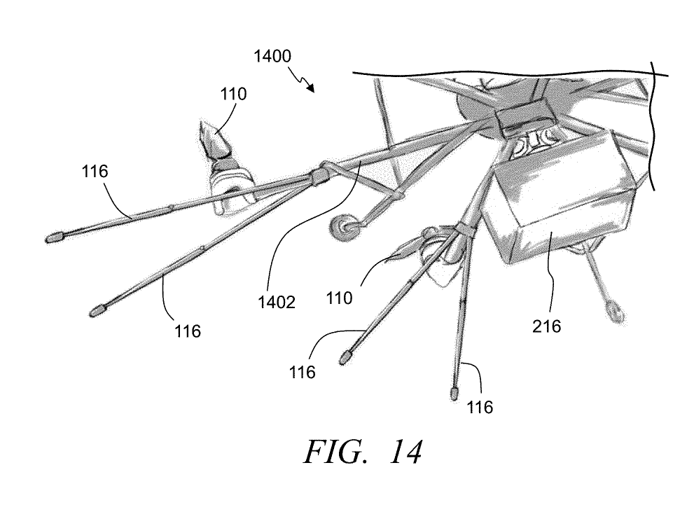

The use of tactile sensor systems with extended feeler antennae, however, allow for close-in sense and avoid, but add the further benefit of serving as a buffer between unmanned vehicles (e.g., the propellers) and external physical objects (living and otherwise) that could damage or be damaged by the unmanned vehicle. These extended feeler antennae can be oriented passively, or in some instances be controlled or guided. Antennae motors can be controlled by the vehicle control circuit to move through movement patterns. In other instances, the vehicle control circuit can utilize sensor data to control the movement of one or more extended feeler antennae. For example, the vehicle control circuit can perform image and/or video processing (or a separate video and/or image processing system coupled with the vehicle control circuit) to evaluate image and/or video data. Additionally or alternatively, other sensory cues can be utilized to direct the movement of one or more extended feeler antennae in a desired direction (e.g., toward an external object). The object touched by the antennae, if it has its own sensory system, may react to the touch before making contact with harmful parts of the unmanned vehicle, such as the propellers, wheels, etc. One or more extended feeler antennae may protrude outward and proximate one or more of the propellers. For example, one or more extended feeler antennae may extend from motor arms of an unmanned vehicle, though there could be one or many antennae. FIG. 14 illustrates a simplified representation of a portion of an unmanned aerial vehicle 1400 carrying a package 216, in accordance with some embodiments. One or more extended feeler antenna 116 extend from motor arms 1402 and positioned proximate corresponding propellers 110. In some implementations, the extended feeler antennae stay extended. In other implementations, one or more of the extended feeler antennae or a portion of the extended feeler antennae may be retracted or folded back for streamlining and extended when needed (e.g., as during landing, delivery, and other instances when the unmanned vehicle would be flying more slowly). In some embodiments, one or more of the extended feeler antennae may include its own optics at or proximate the distal end 118, along the base or the like. Some extended feeler antennae are arranged as an array of thinner antennae more akin to animal whiskers cooperated with contact sensors that would provide a thin but detectable buffer yet would have a minimal impact on streamlining, and limited or no impact should a propeller somehow came into contact with one of these thinner antennae. The extended feeler antennae may be constructed of carbon fiber technology, aluminum, fiberglass, plastic, other such materials or combination of such materials. In some implementations, the unmanned vehicle responds to contact with an external object generally by moving away from the contact. Further, some embodiments provide a direct or reflex response directly to the antenna motor, which may provide a fractionally quicker reaction time. Hardware may be utilized to speed up the nearby motor, causing the unmanned vehicle to pull away. As described above, in some embodiments, the extended feeler antennae may be implemented with a springiness, particularly if using a lightweight material, whereby the antennae might prevent the unmanned vehicle from contacting an object by springing the unmanned vehicle away from the object.

The tactile sensor systems can provide a supplement or even an alternative to close in sense and avoid systems of unmanned vehicles, such as typically optically based systems. The tactile sensors systems, by making first contact with an object, can prevent damaging contact by allowing the unmanned vehicle and/or the object to respond evasively. The extended feeler antennae may be constructed to bend or even break, for example, from a tug, at a force less than could be used to pull the unmanned vehicle down. Further, the extended feeler antennae can be positioned to create buffer about the perimeter of the unmanned vehicle. The extended feeler antennae can be resilient enough, and perhaps has a wider fork at the end or is connected with other antennae such that it can spring the unmanned vehicle away from an object or at least assist in the evasion. In some embodiments, the extended feeler antenna can be controlled (e.g., based on contact sensor data and/or other sensor cues) so that the antennae is likely contact the object at on optimal angle (e.g., perpendicular angle) to the oncoming force from that object.

In some implementations, one or more of the extended feeler antennae may include or carry sensors or elements used by other sense and avoid sensors, for example, a fiber optic lens at the tip attached to an imager. For a second example, the extended feeler antennae used as a tactile sensor may also supplement or replace the communications antennae. The tactile sensor systems may provide multiple roles. For example, the extended feeler antennae may have dual use as a sonar sensor sonar-based navigation where the added surface area is useful. The extended feeler antennae may be fully extended all the time, while in other instances one or more extended feeler antenna may be extended during certain situations (e.g., extended feeler antennae are deployed during the last fifty feet but otherwise retracted or folded back for streamlined travel at speed). All or part of the extended feeler antennae may be retract, for example, leaving one or more deployed is dually used as a communications antennae. As introduced above, some embodiments utilize a whisker configuration of multiple extended feeler antennae where the antennae are thin, one of multiples, and brush detects objects that may otherwise be missed or not understood. Contact with extended feeler antennae may allow or encourage the external object to respond evasively before a more serious contact is made. Further, in some applications one or more of the extended feeler antennae can be utilized to confirm location and/or movement, such as confirm a landing pad by touch. Such tactile sensor systems may allow an unmanned vehicle to proceed at an appropriate speed into space that would be too risky for optical and/or other sensors alone. Typically, the extended feeler antennae are given ample freedom of action to move about, but are physically or through software prevented from interacting with the propellers. Further, in some embodiments fiber optics or other light or audible elements cause the antennae or another light source to glow or cause an element to make sound prior to a potential contact, serving as a warning that might prevent that contact before it occurs. Sound or noise could be of the extremely annoying kind, such as the sounds of a swarm of hornets or a baby crying that we are genetically program to respond to rather than ignore. Different types of extended feeler antennae may be used on a single unmanned vehicle (e.g., an array of extended feeler antenna on the usual forward motion of travel may be different from an array in other directions, possibly more robust where there is a greater source of likely threat). The extended feeler antennae may be straight, jointed, articulated via small segmentation, or other configurations. Further, some extended feeler antennae may have their own sub-antennae.

In some applications, one or more of the extended feeler antennae may be deploy as needed, for example, on the side of the unmanned vehicle facing obstacles and not on a side without obstacles, which may be dependent on visual cues and/or other sensor data (e.g., distance measurement sensor systems). Again, some extended feeler antennae push off the potentially harmful object, using the object's mass as a means to stay away from the object. The actions taken in response to contact may include reflex response to speed up a motor nearest the object so that the unmanned vehicle takes an evasive maneuver with the fastest possible response. Further, some extended feeler antennae are jointed, which may be locks down for potential impacts so benefits of stiffness can be achieved, such as pushing the unmanned vehicle way from the object. In some instances, one or more extended feeler antennae may be bent or have additional surface area proximate the distal end 118, perhaps to increase the surface area at the potential point of contact while far enough away not to impact the airflow of the propellers. Antennae motors may be used to provide a detect function by sweeping either in response to other sensors or as a primary sensor. In some embodiments, the tactile sensor systems cooperate with other sensor systems. For example, an extended feeler antenna may include fiber optics. Similarly, the movement of the extended feeler antenna can be controlled to inspect the unmanned vehicle, package or the like (e.g., allowing antenna to look inward at parts of the unmanned vehicle for potential problem troubleshooting, such as, looking at a package and claw problem). Hollow portions of the unmanned vehicle (e.g., arms or groves in arms of the unmanned vehicle) could be a place to keep an antenna when not deployed.

In some embodiments, provide protection to the propellers and/or the unmanned vehicle through the tactile sensor systems 114 without having to pay the price of a shroud (e.g., the added weight and drag associated with a propeller shroud). The extended feeler antennae may extend out to protect the propellers, wheels, and the unmanned vehicle. They can retract in some applications, for example, when the unmanned vehicle is at sufficient altitude to be clear of obstacles. Further, many of the extended feeler antennae are designed to limit drag, such as whiskers like extended feeler antennae that may follow air flow lines. Extended feeler antennae geometry may be curved or straight. Rigid antennae, in some applications, may be folded back to reduce drag while underway at altitude. Further, rigid antennae could be connected with a thin line or wire to detect objects between the antennae. The extended feeler antennae may be extended above and below the unmanned vehicle to detect proximity to the ground. The extended feeler antennae is useful in navigation through relatively narrow areas, such as for egress/ingress through doorways, along hallways, entryways, navigating landscaping, moving through distribution centers and warehouses, and the like.

The extended feeler antennae, in some applications, are provided with sensors to detect when the extended feeler antenna contacts an object, at least with a threshold force or pressure. Additional sensors may be added for video image capture, fiber optics, distance measurement, force measurement, pressure measurement, etc. The system may respond to a change in pressure or force monitored by the sensors. In some embodiments, one or more of the extended feeler antennae may include or couple with an RF transceiver connection to aid in radio communications and/or to receive power over RF. Further, one or more of the physical extended feeler antennae may be used to authenticate an unmanned vehicle (e.g., at a kiosk) through tactile or optical communication, which in some instances is more secure than wireless communications. In the event of an encounter with animals, the extended feeler antennae may readily break or be removed from the unmanned vehicle so that the unmanned vehicle may continue an intended task or mission. The vehicle control circuit of the unmanned vehicle may be configured to cause the location and time of the loss of the antenna to be recorded or communicated to a central system. The addition of the extended feeler antennae to the unmanned vehicles adds a level of security to the system that could allow the unmanned vehicles to operate in less explored areas or while carrying dangerous chemicals which may expand rapidly under certain situations. With some articulated extended feeler antennae, when the unmanned vehicle has landed or is within a threshold of the ground, the articulated antennae may be raised, retracted and/or directed at a perceived threat (e.g., animal, child, etc.). This may scare the threat away long enough to complete the task (e.g., package delivery, package retrieval, etc.).

In some embodiments, systems, apparatuses and corresponding methods performed by the systems provide a retail delivery unmanned aerial vehicles. In some embodiments, these unmanned vehicles include: a frame; a plurality of motors cooperated with the frame; a plurality of propellers each secured with and driven by one of the plurality of motors to provide altitude and directional movement of the unmanned aerial vehicle; a vehicle control circuit communicatively coupled with the motors and configured to control the motors in controlling the movement of the unmanned aerial vehicle; and an array of a plurality of tactile sensor systems each comprising: an extended feeler antenna extending from the frame with a distal end proximate one of the propellers and spaced from the frame, wherein the extended feeler antenna is configured to flex in response to a threshold pressure from contact with an external object; and a contact sensor cooperated with the extended feeler antenna and configured to detect contact by the extended feeler antenna with the external object; wherein the extended feeler antennae of the plurality of tactile sensor systems are spaced around the frame and define at least outer most lateral perimeter points laterally spaced about the unmanned aerial vehicle.

Some embodiments provide methods of delivering retail products using a retail delivery unmanned aerial vehicle, comprising: receiving, at a vehicle control circuit of a retail delivery unmanned aerial vehicle, a delivery route to a delivery location; controlling a plurality of motors cooperated with a frame of the unmanned aerial vehicle to each drive one of a plurality of propellers to provide altitude and directional movement of the unmanned aerial vehicle in accordance with the delivery route; receiving, at the vehicle control circuit, contact sensor data from one or more of an array of a plurality of tactile sensor systems each comprising: an extended feeler antenna extending from the frame with a distal end proximate one of the propellers and spaced from the frame, wherein the extended feeler antenna is configured to flex in response to a threshold pressure from contact with an external object; and a contact sensor cooperated with the extended feeler antenna and configured to detect contact by the extended feeler antenna with the external object; wherein the extended feeler antennae of the plurality of tactile sensor systems are spaced around the frame and define at least outer most lateral perimeter points laterally spaced about the unmanned aerial vehicle; and controlling at least one of the motors in response to the contact sensor data.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retail delivery unmanned aerial vehicle, comprising:
a frame;
a plurality of motors cooperated with the frame;
a plurality of propellers each secured with and driven by one of the plurality of motors to provide altitude and directional movement of the unmanned aerial vehicle;
a vehicle control circuit communicatively coupled with the motors and configured to control the motors in controlling the movement of the unmanned aerial vehicle; and
an array of a plurality of tactile sensor systems each comprising:
an extended feeler antenna extending from the frame with a distal end proximate one of the propellers and spaced from the frame, wherein the extended feeler antenna is configured to flex in response to a threshold pressure from contact with an external object; and
a contact sensor cooperated with the extended feeler antenna and configured to detect contact by the extended feeler antenna with the external object;
wherein the extended feeler antennae of the plurality of tactile sensor systems are spaced around the frame and define at least outer most lateral perimeter points laterally spaced about the unmanned aerial vehicle.

2. The unmanned aerial vehicle of claim 1, wherein each of a set of multiple extended feeler antennae of the plurality of feeler antennae comprises an electrically conductive contact pad exposed on an exterior surface of at least a portion of the extended feeler antenna;
each of a set of multiple contact sensors of the plurality of contact sensors comprises an electrical charge storage system electrically coupled with the contact pad and configured to store over time accumulated electrical energy from static electricity, and a discharge sensor configured to detect a discharge of the charge storage system in response to contact by a corresponding one of the contact pads with the external object.

3. The unmanned aerial vehicle of claim 1, wherein each of a set of multiple extended feeler antennae of the plurality of feeler antennae comprises the contact sensor positioned proximate the distal end of the respective extended feeler antenna, wherein the contact sensor comprises an inertial sensor communicatively coupled with the vehicle control circuit and configured to communicate contact sensor data comprising inertia data to the vehicle control circuit, and the vehicle control circuit is configured make a determination that there has been contact with the external object based on identifying from the inertial data a threshold inertia change of at least a portion of at least one of the extended feeler antennae of the set of multiple extended feeler antennae.

4. The unmanned aerial vehicle of claim 1, further comprising:
a temperature change detection system coupled with a temperature conductive surface exposed on an exterior surface of each of a set of multiple extended feeler antennae of the plurality of extended feeler antennae, wherein the temperature change detection system is configured to detect a threshold change in temperature from at least one of the temperature conductive surfaces within a threshold period;
wherein each of a temperature control systems is coupled with the vehicle control circuit and configured to communicate temperature change sensor data to the vehicle control circuit, and wherein the vehicle control circuit is configured make a determination that there has been contact with the external object based on the temperature change sensor data.

5. The unmanned aerial vehicle of claim 1, wherein the vehicle control circuit is configured to:
receive contact sensor data from a first contact sensor cooperated with a first extended feeler antenna in response to the first extended feeler antenna contacting the external object;
identify a first propeller that is positioned closest to the first extended feeler antenna; and
induce an evasive increase in rotational speed of the first propeller in response to contact sensor data indicating contact of the first extended feeler antenna with the external object, while not increasing rotational speed of one or more of the other of the plurality of propellers, and causing at least a portion of the unmanned aerial vehicle proximate the first propeller to move away from the contact.

6. The unmanned aerial vehicle of claim 1, further comprising:
a plurality of motor controllers configured to control one of the plurality of motors;
wherein each of the plurality of motor controllers is directly communicatively coupled with at least one of the contact sensors and configured to receive sensor data from the at least one contact sensor corresponding to a first propeller, and immediately adjust a corresponding first motor to induce an evasive change in rotational speed of the first propeller in response to the received contact sensor data indicating contact with the external object by a first extended feeler antenna corresponding to the at least one contact sensor, while not increasing rotational speed of one or more of the other of the plurality of propellers, and causing at least a portion of the unmanned aerial vehicle proximate the first propeller to move away from the contact.

7. The unmanned aerial vehicle of claim 1, wherein each of the extended feeler antennae comprises a detach coupling configured to cause at least a portion of the extended feeler antenna to detach from the frame in response to a threshold pull force applied to the extended feeler antenna that is directed away from the frame.

8. The unmanned aerial vehicle of claim 1, wherein at least some of the plurality of extended feeler antennae comprise multiple prong sections positioned at the distal end of the respective extended feeler antenna and about a corresponding one of the propellers proximate the respective extended feeler antenna.

9. The unmanned aerial vehicle of claim 1, further comprising:
a plurality of antenna motors each cooperated with one of the extended feeler antennae and communicatively coupled with the vehicle control circuit, wherein the vehicle control circuit is configured to control the plurality of antenna motors to cause a change of position of the extended feeler antennae relative to the frame.

10. The unmanned aerial vehicle of claim 9, wherein the vehicle control circuit is configured to control the plurality of antenna motors to cause a distal end of each of the plurality of extended feeler antennae to repeatedly sweep along a movement path proximate a corresponding one of the plurality of propellers.

11. The unmanned aerial vehicle of claim 9, wherein the vehicle control circuit is configured to identify a direction of travel of the unmanned aerial vehicle and to control one or more of the plurality of antenna motors to position one or more of the extended feeler antennae to align with the direction of travel.

12. The unmanned aerial vehicle of claim 9, wherein a first feeler antenna comprises a hinge between two longitudinal body sections;
a first antenna motor of the plurality of antenna motors is configured to cause the first extended feeler antenna to bend at the hinge; and
wherein the vehicle control circuit is configured to control the first antenna motor in response to a direction of travel of the unmanned aerial vehicle and a speed of the unmanned aerial vehicle exceeding a speed threshold.

13. The unmanned aerial vehicle of claim 9, further comprising:
at least one additional proximity sensor coupled with the vehicle control circuit and configured to communicate proximity sensor data to the vehicle control circuit; and
wherein the vehicle control circuit is configured to control at least a first antenna motor of the plurality of antenna motors to move a distal end of a first extended feeler antenna cooperated with the first antenna motor relative to a first propeller based on the proximity sensor data.

14. The unmanned aerial vehicle of claim 1, wherein the extended feeler antennae comprise a longitudinal body configured to deflect in response to contact and exert an increasing opposing force as a function of the amount of deflection within a deflection threshold.

15. The unmanned aerial vehicle of claim 1, wherein the extended feeler antennae comprise:
a longitudinal body extending away from the frame; and
a spring member cooperated with the longitudinal body, wherein the spring member is configured to deflect in response to the longitudinal body contacting the external object enabling the flexing of the extended feeler antennae.

16. The unmanned aerial vehicle of claim 1, wherein the vehicle control circuit is configured to detect a speed of the unmanned aerial vehicle greater than a speed threshold in a first direction and cause one or more of the plurality of extended feeler antennae to be put in a stowed position as a function of the first direction and in response to the speed of the unmanned aerial vehicle being greater than the speed threshold.

17. A method of delivering retail products using a retail delivery unmanned aerial vehicle, comprising:
receiving, at a vehicle control circuit of a retail delivery unmanned aerial vehicle, a delivery route to a delivery location;
controlling a plurality of motors cooperated with a frame of the unmanned aerial vehicle to each drive one of a plurality of propellers to provide altitude and directional movement of the unmanned aerial vehicle in accordance with the delivery route;
receiving, at the vehicle control circuit, contact sensor data from one or more of an array of a plurality of tactile sensor systems each comprising: an extended feeler antenna extending from the frame with a distal end proximate one of the propellers and spaced from the frame, wherein the extended feeler antenna is configured to flex in response to a threshold pressure from contact with an external object; and a contact sensor cooperated with the extended feeler antenna and configured to detect contact by the extended feeler antenna with the external object;
wherein the extended feeler antennae of the plurality of tactile sensor systems are spaced around the frame and define at least outer most lateral perimeter points laterally spaced about the unmanned aerial vehicle; and
controlling at least one of the motors in response to the contact sensor data.

18. The method of claim 17, further comprising:
storing electrical energy accumulated over time from static electricity in an electrical charge storage system of each of a set of multiple contact sensors of the plurality of contact sensors; and
detecting a discharge of at least some of the electrical charge stored in a corresponding one of the charge storage systems in response to contact of an electrically conductive contact pad, exposed on an exterior surface of a corresponding one of the plurality of extended feeler antennae, with the external object.

19. The method of claim 17, wherein the receiving the contact sensor data comprises receiving contact sensor data from a first contact sensor cooperated with a first extended feeler antenna in response to the first extended feeler antenna contacting the external object;
identifying a first propeller that is positioned closest to the first extended feeler antenna; and
wherein the controlling at least one of the motors in response to the contact sensor data comprises inducing an evasive increase in rotational speed of the first propeller in response to contact sensor data indicating contact of the first extended feeler antenna with the external object, while not increasing rotational speed of one or more of the other of the plurality of propellers, and causing at least a portion of the unmanned aerial vehicle proximate the first propeller to move away from the contact.

20. The method of claim 17, further comprising:
controlling a plurality of antenna motors to cause a change of position of the extended feeler antennae relative to the frame.

21. The method of claim 20, wherein the controlling the plurality of antenna motors to cause the change of position of the extended feeler antennae comprises controlling the plurality of antenna motors to cause a distal end of each of the plurality of extended feeler antennae to repeatedly sweep along a movement path proximate a corresponding one of the plurality of propellers.

22. The method of claim 20, wherein the controlling the plurality of antenna motors to cause the change of position of the extended feeler antennae comprises:
identifying a direction of travel of the unmanned aerial vehicle; and
controlling one or more of the plurality of antenna motors to position one or more of the extended feeler antennae to align with the direction of travel.

23. The method of claim 20, wherein the controlling the plurality of antenna motors to cause the change of position of the extended feeler antennae comprises controlling a first antenna motor of the plurality of antenna motors causing a first extended feeler antenna to bend at a hinge of the first extended feeler antenna in response to a direction of travel of the unmanned aerial vehicle and a speed of the unmanned aerial vehicle exceeding a speed threshold.

24. The method of claim 20, further comprising:
obtaining proximity sensor data from at least one additional proximity sensor of the unmanned aerial vehicle; and
wherein the controlling the plurality of antenna motors to cause the change of position of the extended feeler antennae comprises controlling at least a first antenna motor of the plurality of antenna motors to move a distal end of a first extended feeler antenna cooperated with the first antenna motor relative to a first propeller based on the proximity sensor data.

25. The method of claim 17, wherein:
the receiving, at the vehicle control circuit, the contact sensor data comprises
receiving inertia data from at least one of a set of multiple extended feeler antennae of the plurality of feeler antennae comprising an inertial sensor positioned proximate the distal end of the respective extended feeler antenna;
identifying from the inertial data a threshold inertia change of at least a portion of the at least one of the extended feeler antennae of the set of multiple extended feeler antennae; and
making a determination that there has been contact with the external object based on the identified threshold inertia change of at least the portion of the at least one of the extended feeler antennae.
